(19) United States
(12) Patent Application Publication
(10) Pub. No.: US 2022/0163336 A1
(43) Pub. Date: May 26, 2022

(54) RIDESHARE SYSTEM IMPLEMENTING PEAK-SHAVING FOR FLEET VEHICLE OPERATORS

(71) Applicant: Uber Technologies, Inc., San Francisco, CA (US)

(72) Inventors: Miraj Rahematpura, San Francisco, CA (US); Aaron McCullough, San Francisco, CA (US); Nirveek De, San Francisco, CA (US); Vishnu Srinivasan Sundaresan, San Francisco, CA (US); Jonathan Correia, San Francisco, CA (US); Cinar Kilcioglu, San Francisco, CA (US); Kenneth Zhou, San Francisco, CA (US); Amy Ko, San Francisco, CA (US); Kevin Johnson, San Francisco, CA (US); Ashwin Prabhu, San Francisco, CA (US); Colleen Shaffer, San Francisco, CA (US); Victor Pereira, San Francisco, CA (US); Diana Robinson, San Francisco, CA (US); Christine Chou, San Francisco, CA (US); Garrett Weiss, San Francisco, CA (US)

(21) Appl. No.: 17/535,878

(22) Filed: Nov. 26, 2021

Related U.S. Application Data
(60) Provisional application No. 63/118,537, filed on Nov. 25, 2020.

(51) Int. Cl. G01C 21/34; G01C 21/00

(52) U.S. Cl. CPC G01C 21/3438; G01C 21/3896; G01C 21/387

(57) ABSTRACT

A computing system can integrate fleet vehicles of a fleet operator into a rideshare network to increase utilization of the fleet vehicles, optimize fleet size for fleet operators, and supplement the fleet vehicles with the rideshare network during peak periods to service the rider base of the fleet operator.

### CROSS REFERENCE TO RELATED APPLICATION

This application claims the benefit of priority to U.S. Provisional Application No. 63/118,537, filed on Nov. 25, 2020, which is hereby incorporated by reference in its entirety.

### BACKGROUND

Fleet vehicle operators—such as public transport entities, companies offering employee busing, rental car companies, and the like—commonly experience underutilization (trips per vehicle hour) of their fleet vehicles. In particular, fleet vehicles may sit idle for most of the day, or even for days on end, without being used for transportation or delivery services, resulting in significant inefficiencies.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example computing system implementing fleet integration for a rideshare service, in accordance with examples described herein;

FIG. 2 is a block diagram illustrating an example computing device executing one or more service applications for communicating with a computing system, according to examples described herein;

FIGS. 3A and 3B illustrate demand curves and peak-shaving prior to and subsequent to fleet integration with a rideshare network, according to examples provided herein;

FIG. 3C is an example client-side user interface showing user options for requesting a ride, according to various examples;

FIG. 4 is a flow chart describing an example method of simulating fleet integration into a rideshare network, according to various examples;

FIGS. 5A through 5C are flow charts describing example methods of integrating fleet vehicles into a rideshare network, according to various examples; and

FIG. 6 is a block diagram that illustrates a computer system upon which examples described herein may be implemented.

### DETAILED DESCRIPTION

Described herein are systems and methods that enable fleet operators to include their fleet vehicles within a rideshare network to increase the utilization of each fleet vehicle at the fleet operator's convenience. The occasional incorporation of these fleet vehicles into a highly utilized rideshare network by way of temporary inclusion within an on-app selection feature can significantly increase the utilization of the operators' fleet vehicles. Furthermore, in periods of high rider demand, the rideshare network can contribute to “peak-shaving” of fleet vehicles—meaning fewer fleet vehicles are necessary for fleet operators to fulfill their expected transport demand, which typically peaks during relatively short periods during the day.

According to examples described herein, a rideshare computing system can provide an inclusive application feature for fleet operators to provide their fleet vehicles as transport supply for a rideshare network when their fleet vehicles are not needed for typical operation of their transport services (e.g., public transport, paratransit, rental vehicle agencies, corporate bus and/or van services for employees, and the like). In various implementations, the application feature can provided as a Software as a Service (SaaS) for fleet operators through their computing systems or devices, which can link the fleet vehicles of the participating fleet operators to the rideshare network that comprises variable transport supply for on-demand rideshare services (e.g., on-demand carpool, single-passenger rideshare, high-capacity vehicle requests, package or comestible goods delivery, health care delivery services, shuttle services, etc.).

For example, a fleet operator may have normal transport services for their rider base that comprise transporting those users during set time slots during the day. Once those normal services are completed, or any time outside these time slots, the fleet operator can initiate the rideshare application provided by the rideshare computing system and task their drivers and/or vehicles to enter the rideshare network, such that those fleet vehicles can be utilized for on-demand transport. When the time slots approach for the fleet vehicles, the fleet operators can exit the rideshare network and resume normal operations.

In certain implementations, the computing system can receive fleet data from a fleet operator, which can comprise the number of fleet vehicles of the operator as well as the operator's transport schedules and routes. The computing system can further comprise a database storing historical utilization data of the rideshare services managed and coordinated by the computing system in a specified geographic area that includes the fleet operator's normal service area. In various examples, the computing system can execute a simulation model comprising the fleet data and the historical utilization data for the geographic area and output a simulated rideshare environment that includes the fleet vehicles of the fleet operator to test the marketplace outcome of incorporating the fleet vehicles into the rideshare network at specified periods during the day. This simulated environment can simulate typical ride requests from requesting users during those periods (e.g., with and without the inclusion of the fleet vehicles). Using the simulation tool, the computing system can provide the fleet operator with an optimal number of fleet vehicles to service its normal operations while maximizing utilization of those vehicles.

Furthermore, the computing system can leverage the on-demand rideshare network to perform “peak-shaving” of the fleet operator's vehicles. This “peak-shaving” comprises an optimized reduction in the fleet operator's vehicle fleet based on the fleet operator's own demand curve for its normal transport services. For example, a typical fleet operator may experience short demand spikes during the day, in which the fleet operator must either service those demand spikes with additional fleet vehicles or allow its riders to experience lengthy wait times. Accordingly, these demand spikes result in upward pressure for both fleet size and wait times during those peak times. Outside the demand spikes, the fleet size can be far larger than rider demand, resulting in significant underutilization of a portion of the fleet vehicles. According to examples provided herein, the computing system can service the demand spikes of the fleet operator using the existing, variable transport supply in the system's rideshare network, thereby eliminating the underutilization of the fleet vehicles, and providing increased efficiency in the rideshare marketplace.

In various implementations, the fleet operator can establish a set of rules for determining when one or more vehicles from the operator's fleet are to be integrated into the rideshare network of the computing system. The rules can correspond to the unique characteristics of the fleet, the individual vehicles of the fleet, and/or an internal schedule indicating when vehicles are needed for the fleet operator's own services. In certain examples, the unique rules of a particular fleet operator can be flexible, such that vehicles can be classified or included between the rideshare network and the fleet operator's services dynamically based on real-time factors, such as changing demand in the rideshare network or a real-time dispatch that requires a particular vehicle in the fleet operator's service. Furthermore, it is contemplated that backfill demand in a fleet operator's services may be difficult or impossible to predict. Accordingly, the fleet operator may be provided with the freedom to establish rules such that fleet vehicles are available to fulfill backfill demand when it arises in the fleet operator's services

According to some examples, the computing system may perform real-time marketplace monitoring for a given area to identify when low vehicle supply, low request demand conditions, or other marketplace imbalances exist at any given time. In such examples, the rules of a particular fleet operator may enable the computing system to dynamically respond to identified marketplace imbalances by including and removing certain fleet vehicles of the particular fleet operator from the rideshare network based on their individual characteristics (e.g., rider capacity) and locations. In further examples, the computing system may provide a notification to the fleet operator when marketplace imbalances exist in the rideshare network, or can provide a real-time marketplace graphic to the fleet operator, which can indicate particular areas of low vehicle supply, excess vehicle supply, low request demand, or excess request demand. The fleet operator is then given the choice to respond to such marketplace imbalances with the fleet operator's vehicles.

In further examples, the fleet operator may be provided with an application feature enabling the fleet operator to incorporate individual vehicles or groups of fleet vehicles—selected by the fleet operator—into the rideshare network at any given time. In such examples, the fleet operator may also remove individual vehicles or groups of vehicles from the rideshare network at any time. On the fleet driver's end, the classification of the driver and/or fleet vehicle operated by the driver may be seamless, and the driver can be assigned tasks via a single interface (e.g., through an application on the driver's computing device or an in-vehicle computing system).

In certain implementations, the fleet operator can include fleet vehicles into the rideshare network based on time blocks or internal schedules. For example, the fleet operator may prioritize pre-scheduled fleet vehicles for its own services, which may be predetermined. In such implementations, the computing system can supplement fleet vehicles with rideshare vehicles when backfill conditions exists (e.g., a fleet driver calling in sick or taking a vacation). As provided herein, a rideshare network refers to the utilization of available drivers and vehicles in a rideshare service region through an application service to perform on-demand and scheduled tasks corresponding to passenger transport, package delivery, food item delivery, grocery delivery, and the like. In the rideshare network, drivers are enabled to indicate availability through an application interface and can exit the rideshare network as desired.

As used herein, a computing device refers to devices corresponding to desktop computers, cellular devices or smartphones, laptop computers, virtual reality (VR) or augmented reality (AR) headsets, tablet computing devices, etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method.

Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

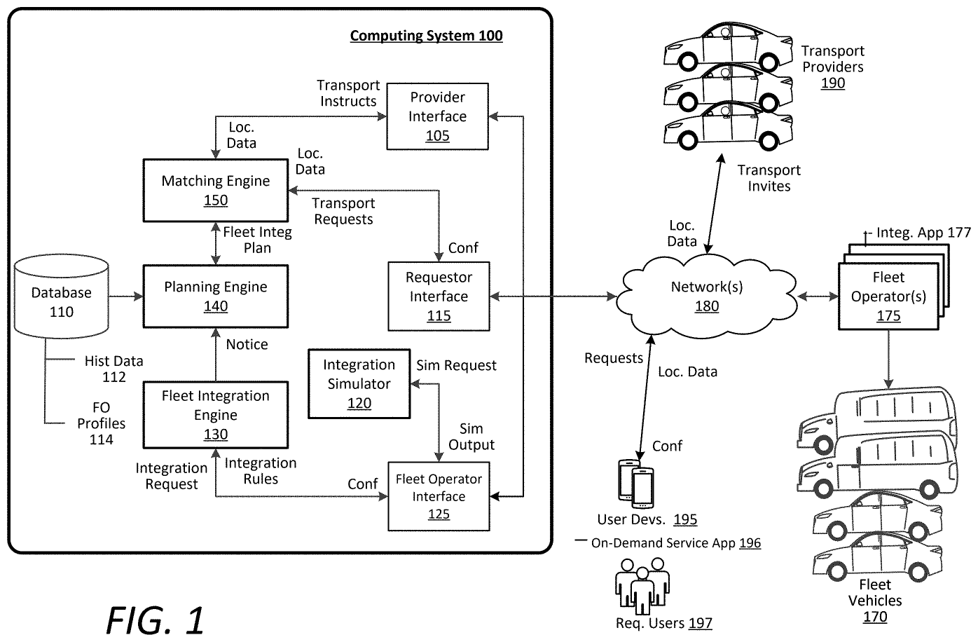

FIG. 1 is a block diagram illustrating an example computing system 100 implementing fleet integration for a rideshare service, in accordance with examples described herein. The computing system 100 can include a matching engine 150 that receives transport requests from the computing devices 195 of requesting users 197 (e.g., via an executing on-demand service application 196) via a requestor interface 115 that connects the computing system 100 to one or more networks 180. In various examples, the transport request can include a pick-up and/or drop-off location for personal transport or goods delivery services. The computing devices 195 of the users 197 may also transmit location data to the matching engine 150 to enable the matching engine 150 to determine an optimal pick-up location for the user 197 and/or for selecting a transport provider 190 to fulfill the transport request.

In various implementations, the matching engine 150 can further receive location data, via a provider interface 105, from the computing devices of the transport providers 190 to determine a current location of each transport provider 190. Based on the location data and pick-up and/or drop-off location indicated in the transport request, the matching engine 150 can select an optimal transport provider 190 to service each received transport request. Upon selecting the optimal transport provider 190, the matching engine 150 can transmit a transport invitation to the selected transport provider 190 to service the transport request. Accordingly, the matching engine 150 can manage and coordinate a variable rideshare network of users 197 and transport providers 190.

In various examples, the computing system 100 can include a fleet operator interface 125 that enables communications, over one or more networks 180 to fleet operators 175 that utilize fleet vehicles 170 to service their riders base. Typically, the fleet operators 175 operate under established schedules and routes that are determined based on internal information of the fleet operators 175, such as booked ride requests, rider demand, work schedules, and the like. As described herein, the fleet operators 175 can comprise public transport operators, paratransit providers, rental vehicle agencies, corporate bus and/or van service operators for employees, health product delivery entities, food delivery operators, school bus operators, and the like. As further described herein, these fleet operators 175 may experience demand peaks and valleys as the day progresses, which result in the fleet operator 175 needing a certain number of fleet vehicles 170 such that peak demand is met, which results in significant underutilization of the fleet vehicles 170 during off-peak periods.

In various examples, the computing system 100 can include an integration simulator 120 that provides the fleet operators 175 with a consultation tool that ultimately provides each fleet operator 175 with an optimal number and/or type of the fleet vehicles 170 that enable the fleet operator 175 to both service its own rider base as well as integrate the fleet vehicles 170 into the rideshare network coordinated by the computing system 100. The integration simulator 120 can receive a simulation request from any particular fleet operator 175. Upon receiving the simulation request, the integration simulator 120 can receive fleet data from the fleet operator 175. The fleet data can comprise the number of fleet vehicles 170 of the operator 175, as well as the operator's transport schedules, routes, and general area in which the fleet operator 175 operates.

In various examples, the computing system 100 can further comprise a database 110 storing historical utilization data 112 of the rideshare service(s) managed and coordinated by the computing system 100 in a specified geographic area that includes the fleet operator's 175 normal service area. In various examples, the integration simulator 120 can execute a simulation model comprising the fleet data and the historical utilization data 112 for the geographic area and output a simulated rideshare environment that includes the fleet vehicles 175 of the fleet operator 175 to determine the marketplace outcome of incorporating the fleet vehicles 175 into the rideshare network at specified periods during the day. As provided herein, the simulation output can comprise a simulation of typical transport requests from requesting users 197 during those periods (e.g., with and without the inclusion of the fleet vehicles 175). In further examples, the integration simulator 120 can perform any number of simulations that adjust the number of fleet vehicles 170 in the rideshare network, and can therefore provide the fleet operator 175 with an optimal number of fleet vehicles 170 (and/or types of fleet vehicles 170) to both service the fleet operator's 175 normal operations while maximizing utilization of those vehicles 170 in the rideshare network facilitated by the matching engine 150.

When a fleet operator 175 decides to opt in to the fleet integration feature of the system 100, a fleet integration engine 130 of the computing system 100 can provide the fleet operator 175 with an integration application 177 (e.g., a SaaS application) that enables the fleet operators 175 or the drivers of the fleet vehicles 170 to enter the rideshare network when the normal transport services of the fleet operator 175 are completed (or during off-peak periods). Through the integration application 177, the fleet operator 175 or fleet vehicles 175 may transmit integration requests to the fleet integration engine 130, which can provide a notice to a planning engine 140 of the computing system 100 that a number of fleet vehicles 170 of a particular fleet operator 175 are to enter the rideshare network at a particular time or immediately.

In further implementations, the fleet operator 175 can interact with the integration application 177 to establish a set of rules for integrating the operator's fleet vehicles 170 into the rideshare network. Such rules may be based on the internal schedule(s) of the fleet operator 175 and/or may be based on certain conditions, such as when fleet vehicles are needed for a particular purpose, or when the fleet operator 175 requires one or more vehicles from the rideshare network to fulfill backfill conditions (e.g., due to an unavailable fleet driver). The rules of the fleet operator 175 may be utilized by the fleet integration engine 130 in determining when individual fleet vehicles 170, groups of fleet vehicles 170, particular types of fleet vehicles 170 (e.g., buses or vans), are available or unavailable for integration with the rideshare network.

In various examples, the planning engine 140 can perform a lookup in the database 110 of a fleet operator profile 114 of the requesting fleet operator 175 to determine the vehicle types, passenger capacity, and availability of fleet vehicles 170 to be integrated into the rideshare network. In some examples, the planning engine 140 can establish a geofence within the service region of the rideshare network as a geographic constraint for the fleet vehicles 170 (e.g., so that the fleet vehicles 170 can exit the rideshare network at any time and remain within a reasonable proximity to a home location of the fleet operator 175). Additionally or alternatively, if the fleet vehicles 170 comprise high-capacity vehicles, the planning engine 140 can constrain the fleet vehicles 170 to high demand “corridors,” in which the fleet vehicles 170 can generally serve transport requests directionally through one or multiple parallel throughways.

Based on the type of fleet vehicles 170 and the time and/or condition constraints of the fleet vehicles 170, the planning engine 140 can generate a fleet integration plan for the matching engine 150, which can cause the matching engine 150 to migrate transport supply accordingly. For example, if the fleet integration plan indicates an imminent influx of fleet vehicles 170 into the rideshare network in a localized area, the matching engine 150 can proactively move transport providers 190 away from that localized area by matching the transport providers 190 to transport requests originating from outside the localized area (e.g., the geofenced area that corresponds to the fleet vehicles 170 being integrated). Once the fleet vehicles 170 are integrated into the rideshare network, the matching engine 150 can continue to receive transport requests from requesting users 197, and determine a set of candidate transport providers 190 to service each transport request—where the candidate set may include one or more fleet vehicles 170 of the fleet operator 175.

In certain implementations, the planning engine 140 and matching engine 150 can facilitate certain transport requests with multi-modal transport options. In the example of the high capacity fleet vehicles 170 servicing transport requests directionally down corridors of parallel streets, a requesting user 197 seeking to be dropped off within, for example, five city blocks of the directional corridor may be matched with a fleet vehicle 170 for a first leg of the journey, and then a reserved electric scooter, bicycle, or transport provider 190 for the second leg of the journey. In certain examples, the matching engine 150 can further accommodate scheduled rides using the rideshare network by transmitting transport invitations to fleet vehicles 170 and/or transport providers 190 prior to pick-up times for the scheduled rides. In still further examples, the planning engine 140 can establish fixed stops along the corridors for pick-ups and drop-offs when transport supply conditions are constrained in order to increase rideshare utilization.

In further examples, the on-demand rideshare service may coordinate multi-modal transport for requesting users 197 based on their public transit stops (e.g., train stations or bus stops), such that a more granular journey to their respective destinations may be provided. For example, a fleet vehicle 170 may serve requests through corridors that intersect with or are adjacent to one or more train stations and/or bus stations. The matching engine 150 can match transiting riders on the trains and/or buses with an arriving fleet vehicle 170 to transport the transiting users closer to their respective destinations along the corridor. Furthermore, the matching engine 150 can further match a user 197 with an e-scooter, bicycle, or transport provider 190 for the final leg of the user's 197 journey.

When an end time for the fleet vehicles 170 nears, the fleet integration plan from the planning engine 140 can indicate that the fleet vehicles 170 must be at or near certain locations to facilitate their normal rider base (e.g., at a peak time period during the day). According to the fleet integration plan, the matching engine 150 can migrate the fleet vehicles 170 to their respective end locations by, for example, matching the fleet vehicles 170 to transport requests that have destinations that align with a direction of the end location of the fleet vehicles 170. Thereafter, the fleet operator 175 can use the integration application 177 to exit the fleet vehicles 170 from the rideshare network in order to service its own rider base.

In further implementations, the planning engine 140 can further monitor marketplace conditions of the rideshare network in real-time to determine localized areas of low vehicle supply and areas of high vehicle supply in relation to request demand in these areas. In some aspects, the planning engine 140 can provide a graphic indicating the localized marketplace conditions to the fleet operator 175 through the integration application 177. Based on the localized marketplace conditions, the fleet operator 175 may choose to include fleet vehicles 170 into the rideshare network in certain areas (e.g., when request demand is high relative to vehicle supply and where a fleet vehicle is readily available).

As provided herein, the fleet operator 175 may allocate a portion of its fleet vehicles 170 or the entire fleet at any given time. Furthermore, the planning engine 140 may indicate to the fleet operator 175 a specified number and/or type of fleet vehicle 170 desired or needed at particular locations at any given time based on current or anticipated marketplace imbalances.

Computing Device

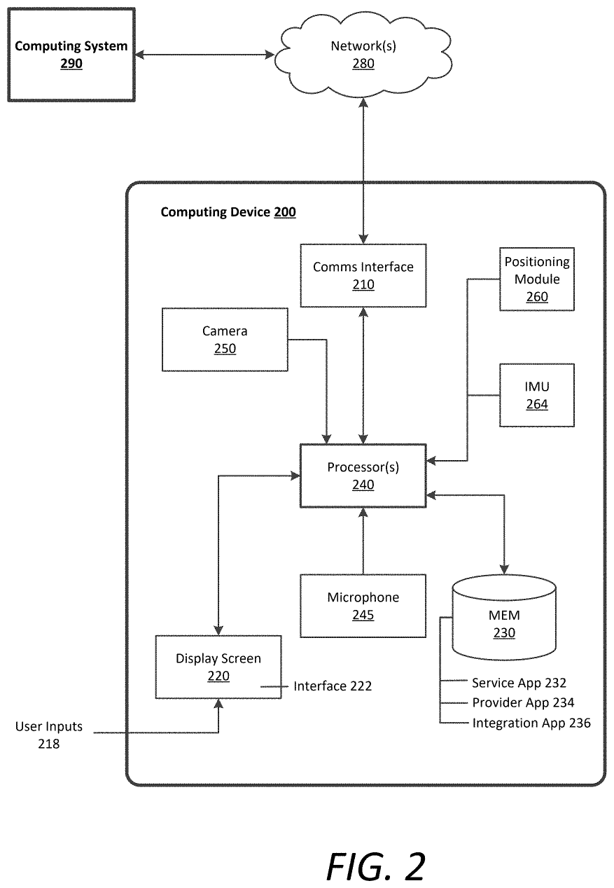

FIG. 2 is a block diagram illustrating an example computing device 200 executing one or more service applications for communicating with a computing system, according to examples described herein. In certain implementations, the computing device 200 can comprise a mobile computing device, such as a smartphone, tablet computer, laptop computer, VR or AR headset device, and the like. As such, the computing device 200 can include telephony features such as a microphone 245, a camera 250, and a communication interface 210 to communicate with external entities using any number of wireless communication protocols. The computing device 200 can further include a positioning module 260 and an inertial measurement unit 264 that includes one or more accelerometers, gyroscopes, or magnetometers.

In certain aspects, the computing device 200 can store a designated on-demand transport service application 232 in a memory 230. In variations, the memory 230 can store additional applications executable by one or more processors 240 of the computing device 200, enabling access and interaction with one or more host servers over one or more networks 280. For example, the computing device 200 can be operated by a requesting user 197 through execution of the on-demand service application 232 to transmit transport requests to the computing system 100. Additionally, the computing device 200 can further be operated by a transport provider 190 through execution of a provider application 234. For requesting user 197 implementations, the user can select the service application 232 via a user input on the display screen 220, which can cause the service application 232 to be executed by the processor 240. In response, a user application interface 222 can be generated on the display screen 220, which can display available transport options and enable the user to configure and submit a transport request.

For transport provider 190 implementations, the provider 190 can select the provider application 234 via a user input 218 on the display screen 220, which can cause the provider application 234 to be executed by the processor 240. In response, a provider application interface 222 can be generated on the display screen 220, which can enable the provider to receive transport invitations, and accept or decline these invitations. The provider app interface 222 can further enable the transport provider to select a current status (e.g., available, on-duty, on-break, on-trip, busy, unavailable, and the like). In still further implementations, the computing device 200 can be operated by a fleet operator 175 to integrate a set of fleet vehicles 170 into the rideshare network managed by the computing system 290, as described above.

As provided herein, the applications 232, 234, 236 can enable a communication link with a computing system 290 over one or more networks 280, such as the computing system 100 as shown and described with respect to FIG. 1. The processor 240 can generate user interface features using content data received from the computing system 290 over network 280. Furthermore, as discussed herein, the applications 232, 234, 236 can enable the computing system 290 to cause the generated interface 222 to be displayed on the display screen 220.

In various examples, the positioning module 260 can provide location data indicating the current location of the users, transport providers, and fleet vehicles to the computing system 290. The content data can cause the executing service application 232, 234, 236 to display the respective interface 222 for each executing application 232, 234, 236. Upon selection of a desired transport option by a requesting user, the service application 232 can cause the processor 240 to transmit a transport request to the computing system 290 to enable the computing system 290 to coordinate with transport providers, including the fleet vehicles, to rendezvous with the user at a selected pick-up location.

Peak-Shaving

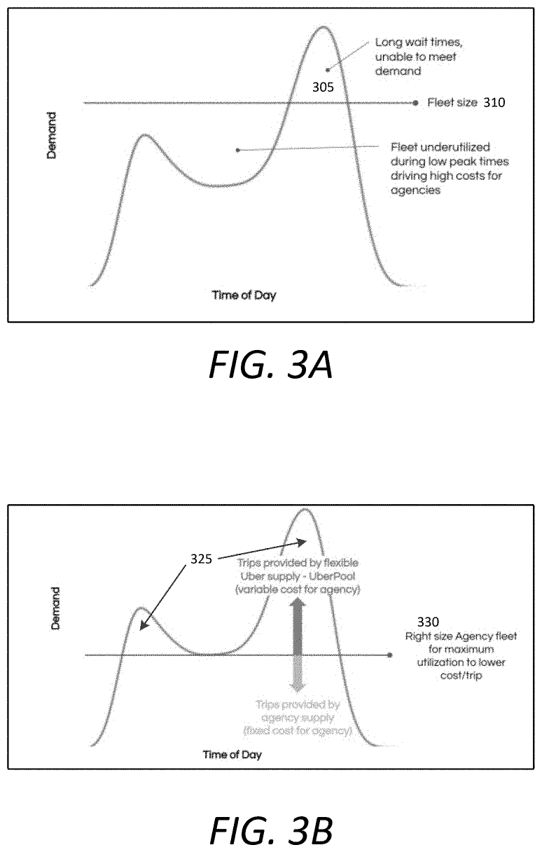

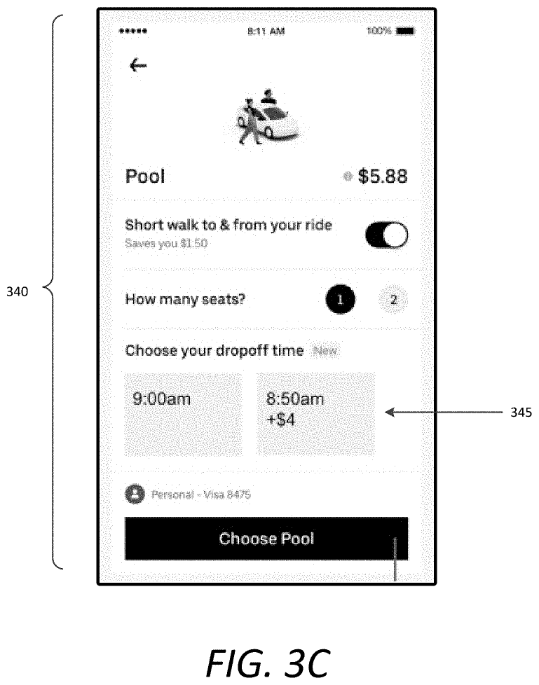

FIGS. 3A and 3B illustrate demand curves and peak-shaving prior to and subsequent to fleet integration with a rideshare network. As described above with respect to FIG. 1, the computing system 100 includes an integration simulator 120 that can output simulation results that identify an optimal number and/or type of fleet vehicle 170 for any given fleet operator 175 in accordance with the fleet operator's 175 fleet data. FIG. 3A shows an example demand curve of a fleet operator 175, which shows a peak 305 in demand in the late afternoon or evening hours. In the example shown in FIG. 3A, the fleet operator 175 may have a fleet size 310 of one hundred vehicles to service the transport demand of its rider base. However, even with one hundred vehicles, the demand peak 305 still indicates that the fleet operator 175 will not be able to meet the demand during the peak period. Furthermore, during off-peak periods, the fleet vehicles 170 will be underutilized, which results in inefficiency and high cost for the fleet operator 175.

As shown in FIG. 3B, the simulation output by the integration simulator 120 can indicate an optimal fleet size 330 for the fleet operator 175 when integrating the fleet vehicles 170 into the rideshare network during off-peak periods, with the rideshare network being utilized to supplement the fleet vehicles 170 and service a portion of the fleet operator's 175 rider base during peak periods 325. As such, the fleet operator 175 can eliminate the underutilization of its fleet vehicles 170 by reducing the fleet size to a more optimal level. Furthermore, the fleet operator 175 can eliminate the long wait times by its rider base during peak periods 325 by utilizing the rideshare network as a supplement to its fleet vehicles 170.

Client-Side Interface

FIG. 3C is an example client-side user interface 340 showing user options for requesting a ride, according to various examples. The user interface feature shown in FIG. 3C can correspond to a carpool option in which fleet vehicles 170 operate through corridors, as described above. For example, when a requesting user 197 is near a corridor, the client-side interface 340 can present a pool option in which the user 197 walks a short distance to the corridor, selects a number of seats, and can select a drop-off time 345. The cost for the trip can vary based on time flexibility and willingness to walk a certain distance. Thus, a later drop-off time enables the matching engine 150 to plan for a later fleet vehicle 170 to pick-up the user 197 instead of rerouting an earlier vehicle 170, which may cause the ETAs of the current riders of the vehicle 170 to increase.

Methodology

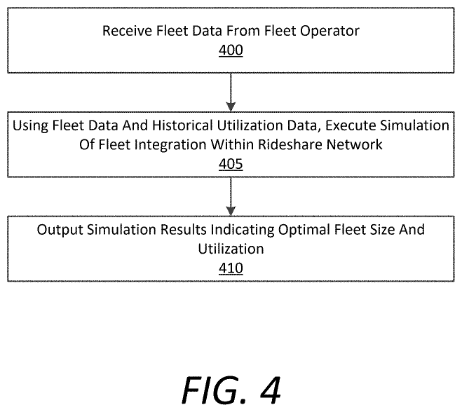

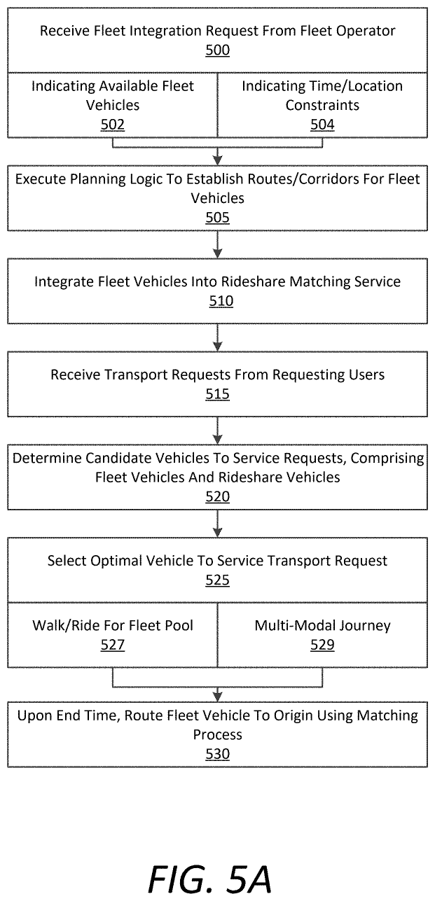

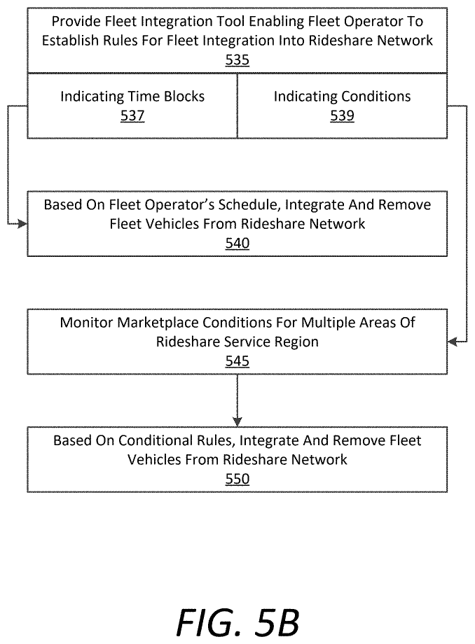

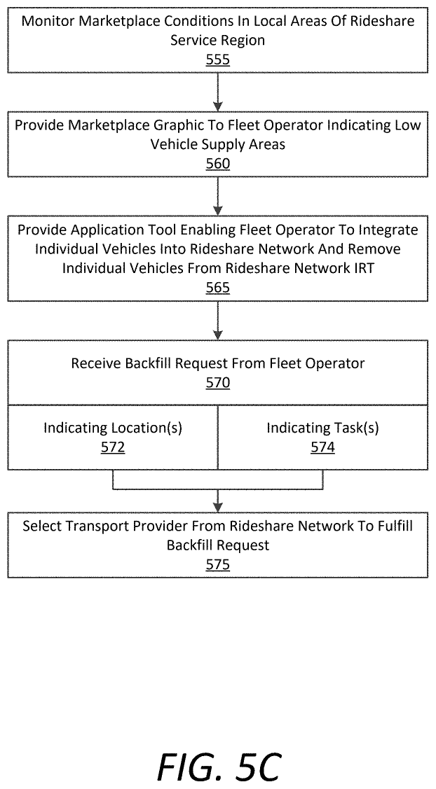

FIGS. 4 and 5A-5C are flow charts describing example methods of simulating fleet integration into a rideshare network and integrating fleet vehicles on-demand into a rideshare network. In the below discussion of FIGS. 4 and 5A-5C, reference may be made to reference characters representing like features as shown and described with respect to FIGS. 1, 2, 3A, 3B, and 3C. The steps described below with respect to the flow charts of FIGS. 4 and 5A-5C need not be performed in any particular order, and each described step may be performed prior to or subsequent to any other step. Furthermore, the processes described with respect to FIGS. 4 and 5A-5C may be performed by an example computing system 100 as shown and described with respect to FIG. 1. Referring to FIG. 4, the computing system 100 can receive fleet data from a fleet operator 175. In various examples, the fleet data can indicate a number of fleet vehicles, a fleet schedule, and a set of fleet vehicle routes of the fleet operator 175. Using the fleet data and historical utilization data 112 of the rideshare service, the computing system 100 can execute a simulation of integrating the fleet vehicles 170 within the rideshare network (405). The computing system 100 may then output simulation results indicating an optimal fleet size and vehicle utilization corresponding to (i) peak-shaving via supplementing peak periods with the rideshare network, and (ii) integrating fleet vehicles 170 within the rideshare network during off-peak periods (410).

Referring to FIG. 5A, the computing system 100 can receive a fleet integration request from a fleet operator 175 (500). In various examples, the fleet integration request can indicate the available fleet vehicles 170, including the type of vehicle (e.g., van, bus, car, or SUV) and the number of vehicles (502). The fleet integration request can further indicate time and location constraints for the fleet being integrated into the rideshare network (504). The computing system 100 may then execute planning logic to establish routes and/or corridors for the fleet vehicles 170 (505), and migrate transport supply according, as described above.

The computing system 100 may then integrate the fleet vehicles 170 into the rideshare service (510). In doing so, the computing system 100 can receive transport requests from requesting users 197 (515), and determine candidate vehicles to service the requests—where the candidate vehicles may include one or more of the fleet vehicles 170 and the variable transport supply of the rideshare service (520). The computing system 100 may then select an optimal vehicle from the candidate set to service the transport request (525). In certain examples, the optimal vehicle may be a fleet vehicle 170 operating through an established corridor, in which case the user 197 may be tasked to walk a certain distance to the pick-up location (527). In variations, the optimal vehicle may transport the user on a leg of a multi-modal journey in which the planning engine 140 has created multiple legs for the user 197 that can involve one or more of: a fleet vehicle 170 operating through a corridor, a transport provider 190 providing on-demand rideshare, a pooled ride, public transit, an e-scooter, or a bicycle (529). At or near the end time for the fleet vehicles 170 in the rideshare network, the computing system 100 can route the fleet vehicles to an origin point or home location using the matching process so that the feet vehicles 170 can service the fleet operator's 175 normal rider based (530).

Referring to FIG. 5B, the computing system 100 can provide a fleet integration tool enabling a fleet operator 175 to establish a set of rules for integrating its fleet vehicles 170 into the rideshare network (535). The fleet integration rules for each fleet operator 175 may be unique based on the individual characteristics of the fleet operator 175, such as the number and type of fleet vehicles 170 (e.g., passenger capacity, cargo space, fleet schedules, fleet services, etc.). The rules may be indicative of time blocks when at least a portion of the fleet vehicles 170 are available (537) (e.g., certain times of the day or night, weekdays and/or weekends, etc.), and/or may be indicative of certain conditions in which at least a portion of the fleet vehicles 170 are available (539) (e.g., based on demand experienced by the fleet operator 175, such as current fleet utilization prescheduled pickup/drop-off tasks, etc.).

In various implementations, the computing system 100 can integrate and remove fleet vehicles 170 from the rideshare network based on the fleet operator's schedule, as determined by the fleet operator's rules (540). Additionally or alternatively, the computing system 100 can monitor marketplace conditions for multiple areas of the rideshare network service region, which can indicate vehicle supply versus transport request demand in each localized area (545). Based on the fleet operator's conditional rules and/or the current marketplace conditions for each localized area, the computing system 100 can integrate and remove vehicles from the rideshare network in real-time (550).

Referring to FIG. 5C, the computing system 100 can monitor marketplace conditions in localized area of the rideshare service region (555). In certain implementations, the computing system 100 can provide a graphic to the fleet operator 175 via the integration application 177 indicating marketplace imbalances in certain localized areas, such as low vehicle supply areas (560). The graphic can comprise a map interface indicating the low supply areas so that the fleet operator 175 can identify available vehicles within its fleet within or proximate to such areas for integration with the rideshare network. In further examples, the computing system 100 can transmit notifications to the fleet operator 175 indicating locations or areas in which available fleet vehicles 170 would be desirable. In either case, the computing system 100 can provide an application tool enabling the fleet operator 175 to integrate individual vehicles 170 into the rideshare network and remove individual vehicles from the rideshare network in real time (565).

In certain scenarios, the fleet operator 175 may wish to utilize one or more available transport providers 190 in the rideshare network to fulfill a backfill condition in the fleet operator's services, such as when a fleet driver is unavailable, when a fleet vehicle breaks down and requires service, or when demand conditions in the fleet operator's service becomes unpredictably high. In such scenarios, the fleet operator 175 may configure and transmit a backfill request to the computing system 100. The computing system 100 may then receive the backfill request from the computing device of the fleet operator (570). The backfill request can indicate pickup and/or drop off locations (572) and the nature of the task(s) required (574). Using the location information and task information, the computing system 100 may then determine one or more candidate transport providers 190 to service the backfill request (e.g., transport providers 190 having the appropriate vehicle type and who are located within a certain proximity to the location of the required task(s)), and select one or more optimal transport providers 190 from the rideshare network to fulfill the backfill request, in accordance with the matching examples described herein (575).

Hardware Diagram

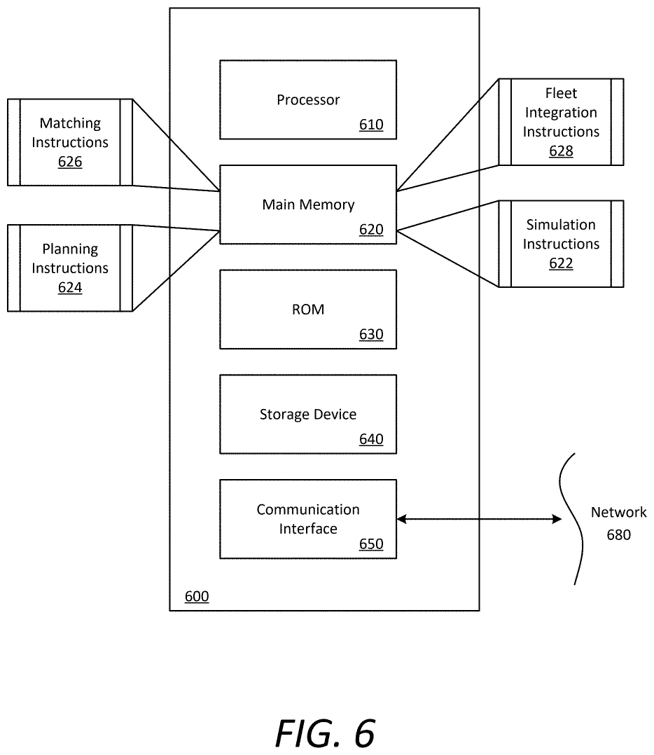

FIG. 6 is a block diagram that illustrates a computer system 600 upon which examples described herein may be implemented. A computer system 600 can be implemented on, for example, a server or combination of servers. For example, the computer system 600 may be implemented as part of a network service, such as described in FIGS. 1 through 5. In the context of FIG. 1, the computer system 100 may be implemented using a computer system 600 such as described by FIG. 6. The computer system 100 may also be implemented using a combination of multiple computer systems as described in connection with FIG. 6.

In various implementations, the computer system 600 includes processing resources 610, a main memory 620, a read-only memory (ROM) 630, a storage device 640, and a communication interface 650. The computer system 600 includes at least one processor 610 for processing information stored in the main memory 620, such as provided by a random-access memory (RAM) or other dynamic storage device, for storing information and instructions which are executable by the processor 610. The main memory 620 also may be used for storing temporary variables or other intermediate information during execution of instructions to be executed by the processor 610. The computer system 600 may also include the ROM 630 or other static storage device for storing static information and instructions for the processor 610. A storage device 640, such as a magnetic disk, optical disk, or memory drive, is provided for storing information and instructions.

The communication interface 650 enables the computer system 600 to communicate with one or more networks 680 (e.g., cellular network) through use of the network link (wireless or wired). Using the network link, the computer system 600 can communicate with one or more computing devices, one or more servers, and/or one or more databases. The executable instructions stored in the memory 630 can include simulation instructions 622, fleet integration planning instructions 624, and matching instructions 626.

By way of example, the instructions and data stored in the memory 620 can be executed by the processor 610 to implement the functions of the computing system 100 of FIG. 1. In various examples, the processor 610 can execute the simulation instructions 622 to determine an optimal fleet size for a fleet operator 175 to service its own rider base, maximize fleet vehicle 170 utilization through integration in the rideshare network, and handle peak periods by utilizing the rideshare network as a supplement to the fleet vehicles 170 of the fleet operator 175. The computer system 600 can further execute the planning instructions 624 to receive fleet vehicle information when integration is requested by a fleet operator 175 and generate a fleet integration plan for the matching process, as described herein. The computer system 600 can further execute the matching instructions 626 to receive transport requests from requesting users 197 and match the users 197 with optimal vehicles, which may include the integrated fleet accordingly.

The instructions can further include fleet integration instructions 628, which the processor 610 executes to enable fleet operators 175 to establish fleet integration rules for including and removing fleet vehicles 170 from the rideshare network, provide marketplace condition information to fleet operators 175, enable the fleet operators 175 to include and remove fleet vehicles 170 from the rideshare network in real-time, and fulfill backfill requests from the fleet operators 175 in accordance with the examples described herein.

Examples described herein are related to the use of the computer system 600 for implementing the techniques described herein. According to one example, those techniques are performed by the computer system 600 in response to the processor 610 executing one or more sequences of one or more instructions contained in the main memory 620. Such instructions may be read into the main memory 620 from another machine-readable medium, such as the storage device 640. Execution of the sequences of instructions contained in the main memory 620 causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A computing system implementing an on-demand transport service for a given geographic region, the computing system comprising:
a network communication interface;
one or more processors; and
a memory storing instructions that, when executed by the one or more processors, cause the computing system to:
manage the on-demand rideshare service for the given geographic region by (i) receiving, over one or more networks, transport requests from computing devices of requesting users of the on-demand rideshare service, (ii) matching each of the requesting users with an available driver from a set of candidate drivers operating pool of available transport vehicles throughout the given geographic region, and (iii) for each requesting user, transmitting, over the one or more networks, a transport invite to a computing device of the available driver matched with the requesting user;
receive, over the one or more networks, a fleet integration request from a computing device of a fleet operator, the fleet integration request comprising a request to include a set of fleet vehicles of the fleet operator with the on-demand rideshare service; and
for at least some of the received transport requests from the requesting users, incorporate one or more fleet vehicles of the fleet operator in the pool of available transport vehicles.

2. The computing system of claim 1, further comprising:
a database storing historical utilization data of the on-demand transport service for the given geographic region, the historical utilization data indicating historical transport requests from requesting users and transport services provided for the requesting users throughout the given geographic region.

3. The computing system of claim 2, wherein the executed instructions further cause the computing system to:
receive, over the one or more networks, fleet data from the computing device of the fleet operator, the fleet data comprising a number of fleet vehicles, a fleet schedule, and a set of fleet vehicle routes of the fleet operator;
execute simulation logic to determine, based on the historical utilization data and the fleet data, an optimal number of fleet vehicles for the fleet operator for providing transport for a rider-base of the fleet operator and incorporating the fleet vehicles in the pool of available transport vehicles of the on-demand transport service.

4. The computing system of claim 3, wherein executing of the simulation logic causes the computing system to further determine the optimal number of fleet vehicles for the fleet operator by simulating, using the historical utilization data, typical ride requests from requesting users during specified periods with and without inclusion of the fleet vehicles in the pool of available transport vehicles.

5. The computing system of claim 1, wherein the fleet operator provides the fleet supply request via an integration application feature displayed on the computing device of the fleet operator that enables the fleet operator to integrate the set of fleet vehicles within the pool of available vehicles.

6. The computing system of claim 1, wherein the fleet operator comprises one of a public transport operator, a paratransit operator, a rental vehicle service agency, a corporate bus and/or van service agency, or a delivery service agency.

7. A computing system comprising:
a network communication interface;
one or more processors; and
a memory storing instructions that, when executed by the one or more processors, cause the computing system to:
receive, from a computing device of a fleet operator, a set of rules corresponding to integrating fleet vehicles of the fleet operator into a rideshare network managed by the computing system; and
based at least in part on the set of rules, integrate one or more of the fleet vehicles into the rideshare network at a given time.

8. The computing system of claim 7, wherein the set of rules corresponds to a schedule of the fleet operator.

9. The computing system of claim 7, wherein the executed instructions cause the computing system to manage the rideshare network by:
receiving, over one or more networks, transport requests from computing devices of requesting users of an on-demand rideshare service;
matching each of the requesting users with an available driver from a set of candidate drivers operating pool of available transport vehicles throughout a given geographic region, and;
for each requesting user, transmitting, over the one or more networks, a transport invite to a computing device of the available driver matched with the requesting user.

10. The computing system of claim 9, wherein the executed instructions further cause the computing system to:
monitor marketplace conditions of the rideshare network for localized areas of the given geographic region, the marketplace conditions indicating low vehicle supply in relation to transport request demand from the requesting users.

11. The computing system of claim 10, wherein the executed instruction further cause the computing system to:
provide marketplace information corresponding to the marketplace conditions to the computing device of the fleet operator;
wherein the fleet operator is enabled to integrate or remove individual fleet vehicles from the rideshare network based on the marketplace conditions.

12. The computing system of claim 7, wherein the executed instructions further cause the computing system to:
receive, from the computing device of the fleet operator, a backfill request for one or more transport providers to fulfill one or more services of the fleet operator; and
based on information included with the backfill request, select one or more transport providers in the rideshare network to fulfill the backfill request.

13. The computing system of claim 12, wherein the information included with the backfill request includes at least one pickup location, at least one drop-off location, or at least one task to perform for the fleet operator.

14. A non-transitory computer readable medium storing instructions that, when executed by one or more processors of a computing system, cause the computing system to:
receive, from a computing device of a fleet operator, a set of rules corresponding to integrating fleet vehicles of the fleet operator into a rideshare network managed by the computing system; and
based at least in part on the set of rules, integrate one or more of the fleet vehicles into the rideshare network at a given time.

15. The non-transitory computer readable medium of claim 14, wherein the set of rules corresponds to a schedule of the fleet operator.

16. The non-transitory computer readable medium of claim 14, wherein the executed instructions cause the computing system to manage the rideshare network by:
receiving, over one or more networks, transport requests from computing devices of requesting users of an on-demand rideshare service;
matching each of the requesting users with an available driver from a set of candidate drivers operating pool of available transport vehicles throughout a given geographic region, and;
for each requesting user, transmitting, over the one or more networks, a transport invite to a computing device of the available driver matched with the requesting user.

17. The non-transitory computer readable medium of claim 6, wherein the executed instructions further cause the computing system to:
monitor marketplace conditions of the rideshare network for localized areas of the given geographic region, the marketplace conditions indicating low vehicle supply in relation to transport request demand from the requesting users.

18. The non-transitory computer readable medium of claim 17, wherein the executed instruction further cause the computing system to:
provide marketplace information corresponding to the marketplace conditions to the computing device of the fleet operator;
wherein the fleet operator is enabled to integrate or remove individual fleet vehicles from the rideshare network based on the marketplace conditions.

19. The non-transitory computer readable medium of claim 14, wherein the executed instructions further cause the computing system to:
receive, from the computing device of the fleet operator, a backfill request for one or more transport providers to fulfill one or more services of the fleet operator; and
based on information included with the backfill request, select one or more transport providers in the rideshare network to fulfill the backfill request.

20. The non-transitory computer readable medium of claim 19, wherein the information included with the backfill request includes at least one pickup location, at least one drop-off location, or at least one task to perform for the fleet operator.
